(19) United States
(12) Patent Application Publication
(10) Pub. No.: US 2011/0101645 A1
(43) Pub. Date: May 5, 2011

(54) Teleswivel Hitch Apparatus

(76) Inventors: Thomas M. Williams, JR., Durham, NC (US); Kampar Kheradpir, Durham, NC (US); Gregory S. Hopper, Raleigh, NC (US)

(21) Appl. No.: 12/917,791

(22) Filed: Nov. 2, 2010

Related U.S. Application Data
(60) Provisional application No. 61/257,249, filed on Nov. 2, 2009.

(51) Int. Cl. B60D 1/44

(52) U.S. Cl. 280/446.1

(57) ABSTRACT

A hitch apparatus includes a frame, spool assembly, and hitch assembly. The frame includes a base with a pair of arms extending away from one side of the base in side by side, spaced-apart relationship. A spool assembly is movably secured to elongated guides associated with the arms so as to be slidable along the arms. A hitch assembly is pivotably secured to the spool assembly and is movable relative to the frame between retracted and extended positions. The hitch assembly includes a pair of spaced apart plate members, each having a recess formed in an outer surface thereof. The spool assembly is pivotably secured within apertures in the plate members, and a guide pin located on each frame arm is operably engaged with a respective recess such that an extent to which the hitch assembly pivots relative to the frame progressively decreases as the hitch assembly is progressively retracted.

### RELATED APPLICATION

This application claims the benefit of and priority to U.S. Provisional Patent Application No. 61/257,249 filed Nov. 2, 2009, the disclosure of which is incorporated herein by reference as if set forth in its entirety.

### FIELD OF THE INVENTION

The present invention relates generally to vehicle towing and, more particularly, to towing hitch apparatus.

### BACKGROUND

Powered and trailed vehicles are conventionally interconnected for travel by coupling hitches involving fixed locations on the vehicles. Using ball and socket-type universal connections or pin-type connections, the required relative movement during travel is provided. The fixed locations, however, may be difficult to effect, particularly with large vehicles that prevent ready manual alignment for final coupling. In many instances, the receiving hitch of a towing vehicle may be misaligned relative to the tongue of a towed vehicle.

When accurate alignment is not obtained, conventionally the towed vehicle is manually moved to proper position, which may require strength, dexterity and multiple personnel, often with an attendant risk of injury. As the tongue weight of a towed vehicle increases, the skill required and risk associated with coupling the towed vehicle to a towing vehicle may be substantially increased. The problem may be particularly troublesome for large steerable wheel trailers, such as those employed by the military.

Telescoping and pivoting hitches have been proposed to allow coupling between misaligned vehicles. Most are designed for lighter weight trailers and unsuited for heavy load applications. Others provide only a length-dependent articulation reducing the accommodated zone of vehicle misalignment.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

According to some embodiments of the present invention, a hitch apparatus includes a frame having an arm, and a hitch assembly movable along the arm between retracted and extended positions. The hitch assembly is also pivotable relative to the frame when in any of the extended positions. In some embodiments, an extent to which the hitch assembly can pivot relative to the frame progressively increases as the hitch assembly is progressively extended. Conversely, an extent to which the hitch assembly can pivot relative to the frame progressively decreases as the hitch assembly is progressively retracted. In some embodiments, a spool assembly is movably secured to the arm and is slidable along the arm. The hitch assembly is pivotably secured to the spool assembly. A locking mechanism is operably secured to the frame and is configured to releasably engage the spool assembly to maintain the hitch assembly in a retracted position.

In some embodiments, the hitch assembly includes a plate member and a hitch box. The hitch box is configured to receive a coupling apparatus therein. The plate member has an aperture formed therethrough and a recess or opening formed in an outer surface thereof adjacent to the aperture. The spool assembly is pivotably secured within the aperture of the plate member, and a guide pin located on the frame arm is operably engaged with the recess or opening. A peripheral wall of the recess or opening limits movement of the hitch assembly relative to the frame. The recess or opening has a configuration that guides the hitch assembly as the hitch assembly is retracted, and also limits an extent to which the hitch assembly can pivot relative to the frame. For example, the recess has a configuration such that an extent to which the hitch assembly can pivot relative to the frame progressively decreases as the hitch assembly is progressively retracted.

According to other embodiments of the present invention, a hitch apparatus includes a frame, a spool assembly, and a hitch assembly. The hitch assembly is movably secured to the frame so as to be movable between retracted and extended positions. In addition, the hitch assembly is pivotable relative to the frame when in any of the extended positions. In some embodiments, the frame includes a base with a pair of arms extending away from one side of the base in side by side, spaced-apart relationship, and a member extending away from an opposite side of the base. The member is adapted to couple with a socket member (often referred to as a “receiver” hitch or mount) attached to a vehicle. In some embodiments, the member may be bolted or otherwise attached to a towed vehicle or towing vehicle without the use of a receiver hitch.

A spool assembly is movably secured to elongated guides associated with the arms so as to be slidable along the arms. The hitch assembly is pivotably secured to the spool assembly and is movable relative to the frame between retracted and extended positions via the spool assembly. In addition, the hitch assembly is pivotably relative to the frame when in any of the extended positions via the spool assembly.

A locking mechanism is operably secured to the frame and is configured to releasably engage the spool assembly to maintain the hitch assembly in a fully retracted position. In some embodiments, the locking mechanism releasably engages an aperture in an intermediate portion of the spool assembly. In some embodiments, the locking mechanism includes a biasing member, such as a spring, that compressively biases a locking member toward the spool assembly aperture. In some embodiments of the present invention, to release the hitching assembly from the locking mechanism, a user grips the locking member and pulls the locking member out of the spool assembly aperture.

In some embodiments, the hitch assembly includes a pair of spaced apart plate members. A hitch box for receiving a coupling apparatus therein is sandwiched between the two plate members. Each plate member has an aperture formed therethrough and a recess or opening formed in an outer surface thereof adjacent to the aperture. The spool assembly is pivotably secured within the apertures of the plate members, and a guide pin located on each frame arm is operably engaged with a respective recess or opening. A peripheral wall of the recess or opening limits movement of the hitch assembly relative to the frame and serves the function of properly guiding the hitch assembly as the hitch assembly is being retracted. The recess or opening of each plate member has a configuration that limits an extent to which the hitch assembly can pivot relative to the frame. For example, each recess or opening has a configuration such that an extent to which the hitch assembly can pivot relative to the frame progressively decreases as the hitch assembly is progressively retracted.

According to other embodiments of the present invention, a hitch apparatus includes a plate member having an aperture formed therethrough and a recess or opening formed in an outer surface thereof adjacent to the aperture. A hitch box is secured to the plate member and is configured to receive a coupling apparatus therein. A spool assembly having an end portion is pivotably secured within the aperture. In some embodiments, the recess or opening has a substantially triangular shape with arcuate sides. In some embodiments, the width of the recess or opening decreases in a direction away from the aperture.

According to other embodiments of the present invention, a hitch apparatus includes a pair of spaced apart plate members and a hitch box positioned between and secured to the plate members. The hitch box is configured to receive a coupling apparatus therein. Each plate member has an aperture formed therethrough and a recess or opening formed in an outer surface thereof adjacent to the aperture. The hitch apparatus also includes a spool assembly having opposite end portions. Each end portion of the spool assembly is pivotably secured within an aperture in a respective plate. In some embodiments, each recess has a substantially triangular shape with arcuate sides. In some embodiments, the width of each recess in a plate decreases in a direction away from the respective plate aperture.

It is noted that aspects of the invention described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below.

### BRIEF DESCRIPTION OF THE DRAWINGS

FIG. 1 is a top perspective view of a hitch apparatus, according to to some embodiments of the present invention.

FIG. 2A is a top perspective view of a base assembly for the hitch apparatus of FIG. 1, according to some embodiments of the present invention.

FIG. 2B is a side view of the base assembly of FIG. 2A.

FIG. 3A is a top perspective view of the base assembly of FIG. 2A coupled with an arm assembly, according to some embodiments of the present invention.

FIG. 3B is a side view of the coupled arm and base assemblies of FIG. 3A.

FIG. 4 is a side view of the hitch apparatus of FIG. 1.

FIG. 5 is an exploded, top perspective view of the hitch apparatus of FIG. 1.

FIG. 6 is a top perspective view of a hitch assembly for the hitch apparatus of FIG. 1, according to some embodiments of the present invention.

FIG. 7 is a top perspective view of a spool assembly for the hitch apparatus of FIG. 1, according to some embodiments of the present invention.

FIGS. 8-10 are top plan views of the hitch apparatus of FIG. 1 illustrating movement of the hitch assembly, according to some embodiments of the present invention.

FIGS. 11-13 illustrate operations for attaching a vehicle to be towed to the hitch apparatus of FIG. 1.

FIG. 14 is a side view of a hitch apparatus, according to some embodiments of the present invention, and wherein the hitch assembly is in a fully retracted position.

FIG. 15 is a top perspective view of the hitch apparatus of FIG. 14 that illustrates the hitch assembly in an extended position.

FIG. 16 is a top perspective view of the hitch apparatus of FIG. 14 that illustrates the hitch assembly in a fully retracted position.

FIG. 17A is a top perspective view of the coupled arm and base assemblies of the hitch apparatus of FIG. 14, according to some embodiments of the present invention.

FIG. 17B is a side view of the coupled arm and base assemblies of FIG. 17A.

FIGS. 18A-18B are top perspective views of the coupled base assemblies of FIG. 17A with additional features added for clarity.

FIG. 19 is a top perspective view of a hitch assembly for the hitch apparatus of FIG. 14, according to some embodiments of the present invention.

FIG. 20 is a top perspective view of a spool assembly for the hitch apparatus of FIG. 14, according to some embodiments of the present invention.

FIG. 21 is a side view of a hitch apparatus, according to some embodiments of the present invention, and wherein the hitch assembly is in a fully retracted position.

FIG. 22 is a bottom perspective view of the hitch apparatus of FIG. 21.

### DETAILED DESCRIPTION

The present invention will now be described more fully hereinafter with reference to the accompanying figures, in which embodiments of the invention are shown. This invention may, however, be embodied in many different forms and should not be construed as limited to the embodiments set forth herein. Like numbers refer to like elements throughout. In the figures, certain features and elements may be exaggerated for clarity, and broken lines illustrate optional features or elements unless specified otherwise. In addition, the sequence of operations (or steps) is not limited to the order presented in the figures and/or claims unless specifically indicated otherwise. Features described with respect to one figure or embodiment can be associated with another embodiment of figure although not specifically described or shown as such.

It will be understood that when a feature or element is referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical” “horizontal” and the like are used herein for the purpose of explanation only unless specifically indicated otherwise.

It will be understood that although the terms first and second are used herein to describe various features or elements, these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The term “vehicle” includes all types of vehicles including, but not limited to, automobiles, trucks, military vehicles, airplanes, trains, etc., and also includes towed vehicles and towing vehicles.

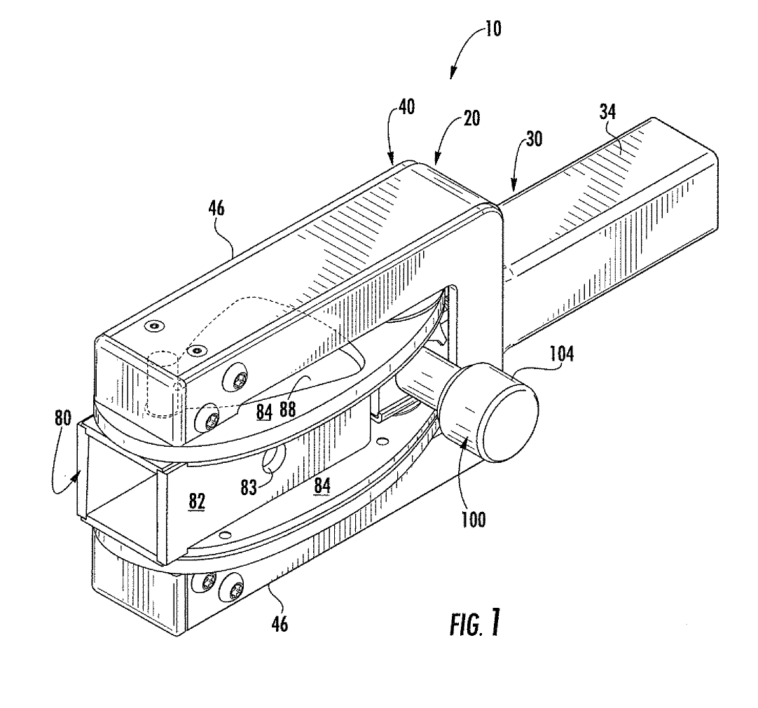

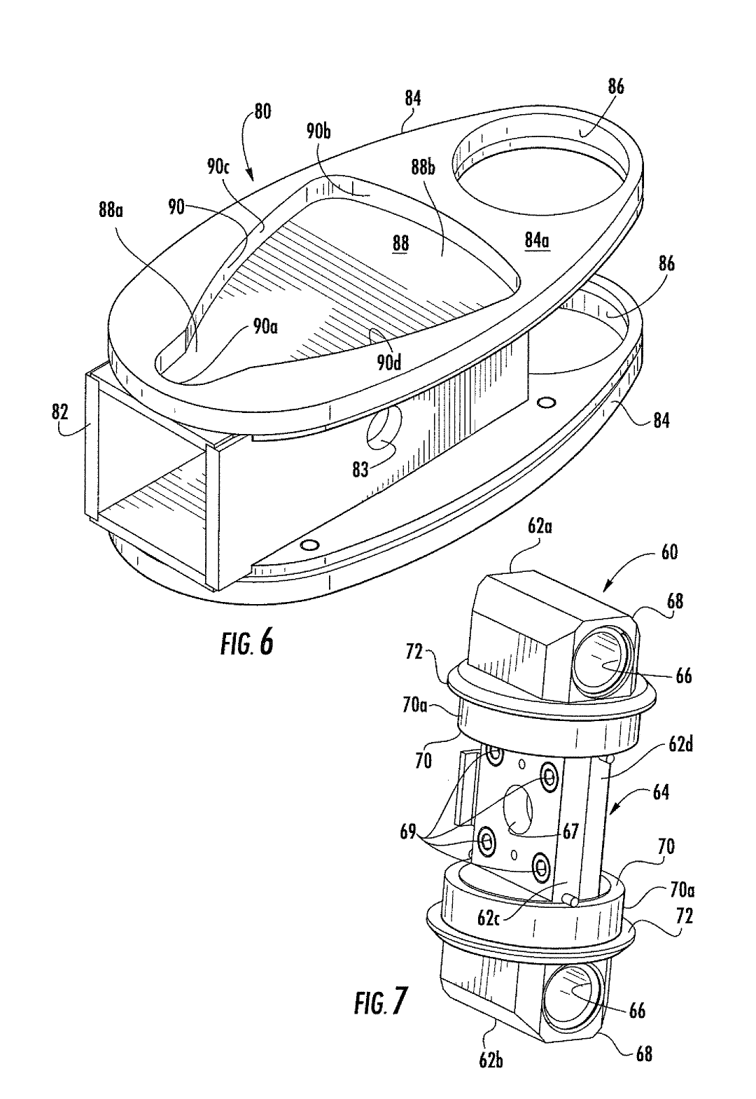

Referring initially to FIGS. 1-7, a hitch apparatus 10, according to some embodiments of the present invention, is illustrated therein. The illustrated hitch apparatus 10 includes a frame 20, a spool assembly 60 (FIG. 7), and a hitch assembly 80. The hitch assembly 80 is movably secured to the frame 20 via the spool assembly 60 (see FIG. 5) so as to be movable between retracted and extended positions. In addition, the hitch assembly 80 is pivotable relative to the frame 20, via the spool assembly 60, when in any of a plurality of extended positions. As will be described in detail below, an extent to which the hitch assembly 80 can pivot relative to the frame 20 progressively increases as the hitch assembly 80 is progressively extended. Conversely, an extent to which the hitch assembly 80 can pivot relative to the frame 20 progressively decreases as the hitch assembly 80 is progressively retracted.

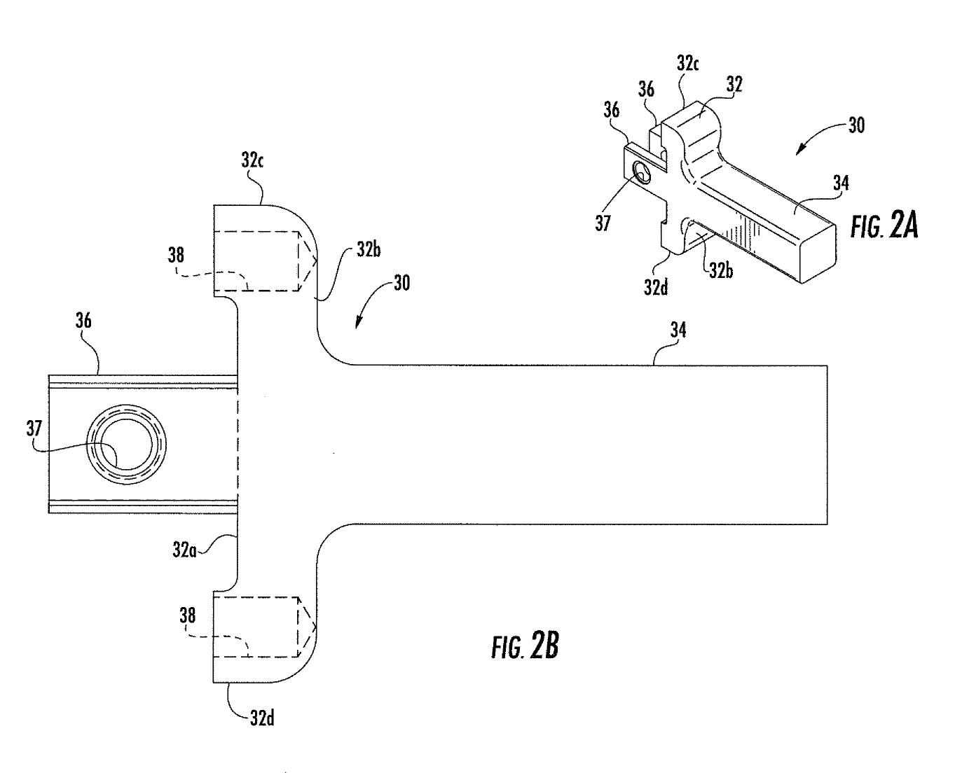

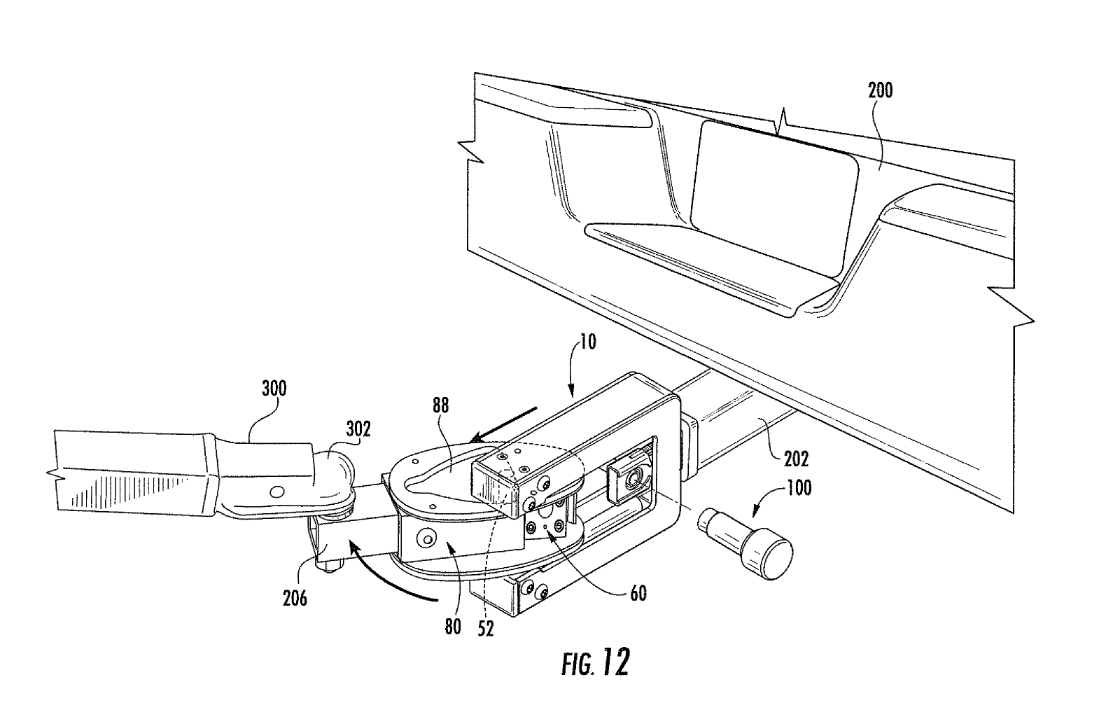

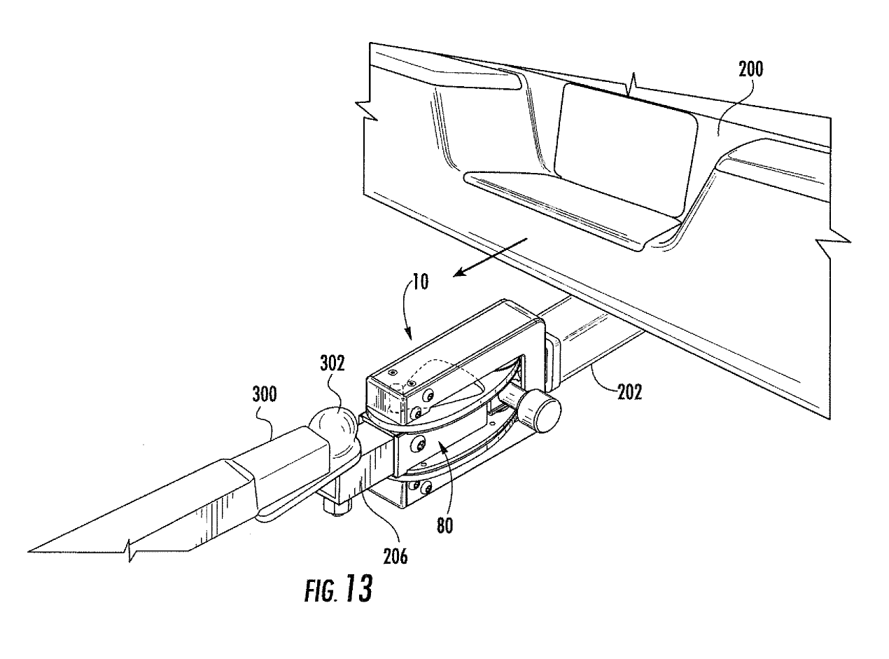

The illustrated frame 20 has a tuning fork configuration and comprises a base assembly 30 and an arm assembly 40. As illustrated in FIGS. 2A-2B, the base assembly 30 includes an elongated base 32 having opposite first and second sides 32a, 32b, and opposite end portions 32c, 32d. An elongated member 34 extends away from the second side 32b of the base 32 and is adapted to couple with a socket member 202 (e.g., a receiver hitch, etc.) mounted to a vehicle 200 (FIGS. 11-13). In some embodiments, the elongated member 34 may be configured/modified to be bolted or otherwise attached to a towed vehicle or towing vehicle without the use of a receiver hitch.

A pair of adjacent, spaced-apart walls 36 extend away from the first side 32a of the base 32. Each of the walls 36 includes an aperture 37 formed therethrough. Walls 36 are adapted to couple with the spool assembly 60 and locking mechanism 100, as will be described in detail below.

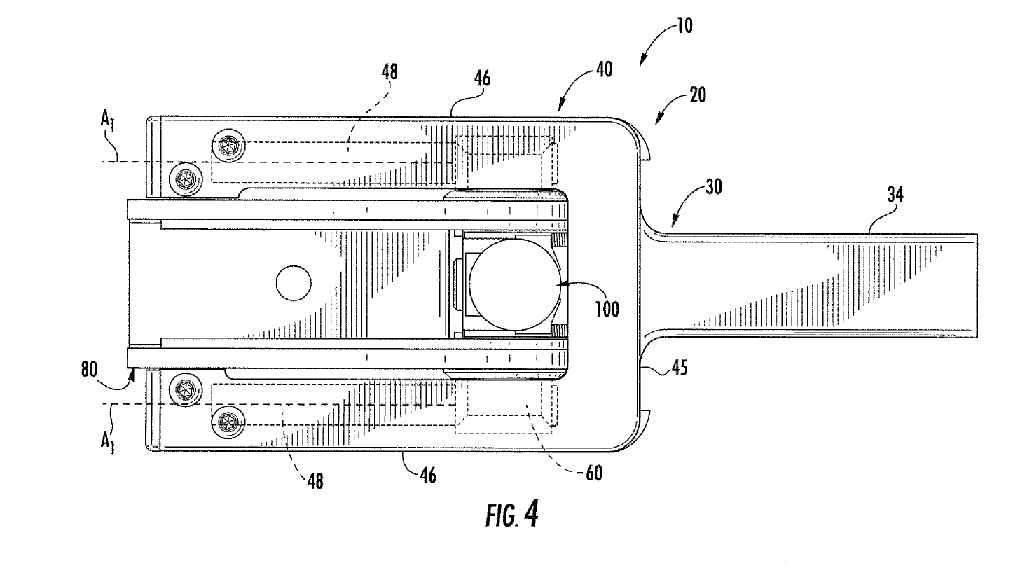

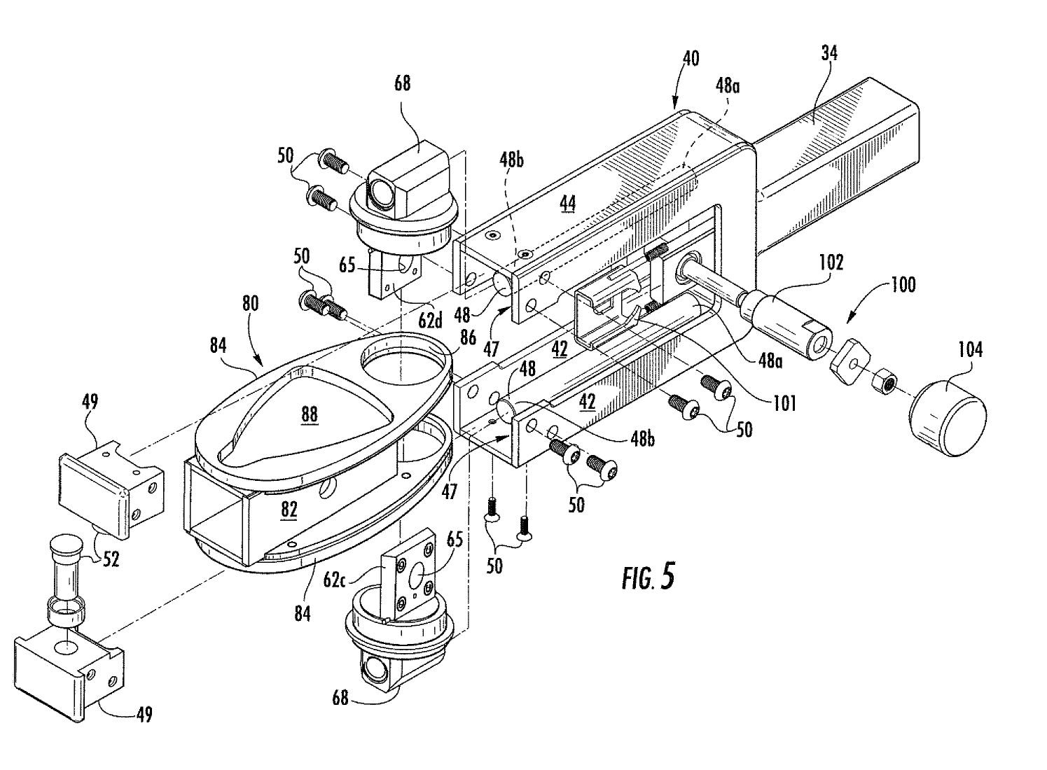

As illustrated in FIG. 2B, each end portion 32c, 32d of the base 32 includes a bore 38 formed therein that terminates at an opening in the first side 32a of the base. Each bore 38 is configured to secure an end portion of a respective elongated rod 48 (FIG. 4) that serves as a guide for slidably supporting the spool assembly 60, as will be described below.

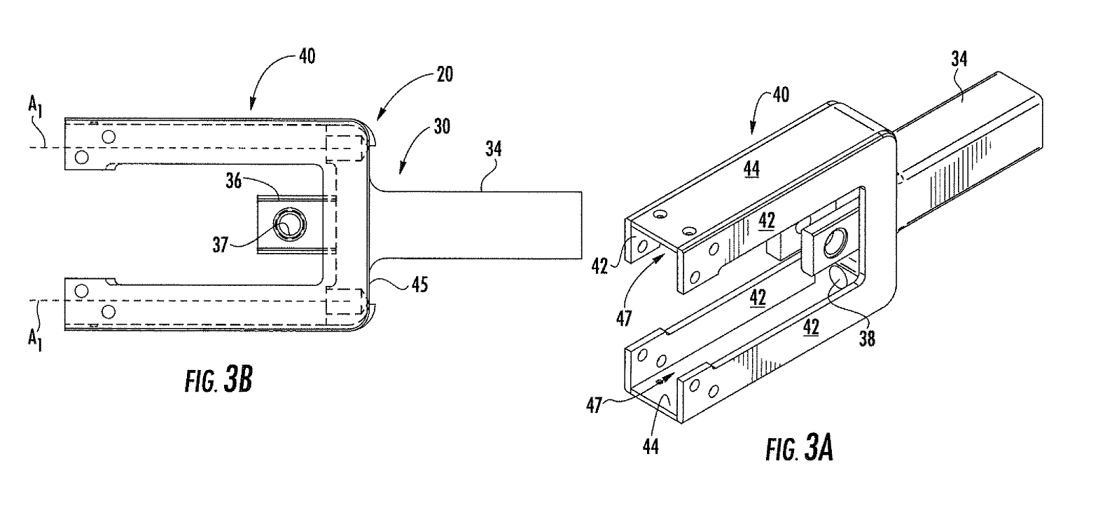

Referring to FIGS. 3A-3B, the base assembly 30 is adapted to be coupled to an arm assembly 40 such that the walls 36 of the base assembly 30 are positioned between the arms 46 of the arm assembly 40 and such that the member 34 extends away from the arm assembly 40. The illustrated arm assembly 40 has a U-shaped configuration and includes a pair of flat, U-shaped wall portions 42 joined to a base plate member 44 in adjacent, spaced-apart relationship such that the wall portions 42 extend outwardly from the base plate member 44. Base plate member 44 includes an opening 45 through which the base assembly member 34 can extend when the base assembly 30 is coupled with the arm assembly 40 to form the frame 20. The base assembly 30 and arm assembly 40 are fixedly secured to each other via welding or fasteners (e.g., bolts, screws, threaded rods, rivets, etc.) or a combination of welding and fasteners.

The U-shaped wall portions 42 and base plate member 44 define a pair of elongated arms 46 (FIG. 4) in adjacent, spaced-apart relationship. The arms 46 lie substantially within the same plane, as illustrated. The orientation of arms 46 and member 34 give the frame 20 its tuning fork shape. Each arm 46 has a U-shaped chamber 47 (FIG. 3A) that extends along and about a longitudinal axis A₁ (FIG. 3B). The U-shaped chamber 47 of each arm is defined by the base plate member 44 and outwardly-extending wall portions 42. As will be described below, the hitch assembly 80 pivots within another plane that is transverse to the plane of the arms 46.

Embodiments of the present invention, however, are not limited to the illustrated configuration of the frame 20. In some embodiments, the frame 20 may be a unitary article (e.g., may be formed or cast) and a separate arm assembly and base assembly may not be necessary. Moreover, embodiments of the present invention are not limited to the illustrated configuration of each elongated arm 46. Although illustrated as defining a U-shaped chamber 47, each arm 46 may have other configurations. The purpose of each arm 46 is to support a respective guide 48 upon which an end 62a, 62b of the spool assembly 60 is movably secured, as will be described below. Various arm configurations may be capable of serving this purpose.

As illustrated in FIG. 4, an elongated guide 48 is disposed within the chamber 47 of each arm 46 and extends along the longitudinal axis A₁ thereof. In the illustrated embodiment, each elongated guide 48 is an elongated rod having a substantially circular cross section. However, guide 48 may have various configurations and shapes as long as the spool assembly 60 can be slidably secured thereto so that the hitch assembly 80 can be extended and retracted, as described below.

In the illustrated embodiment, a first end 48a (FIG. 5) of each elongated guide 48 is secured within a respective bore 38 in the base 32 (FIG. 2B). An opposite second end 48b (FIG. 5) of each elongated guide 48 is secured within a respective endcap member 49 that is attached to the free end of each arm 46 (FIG. 5). As illustrated in FIG. 5, each endcap member 49 is secured to a respective arm free end via a plurality of fasteners 50 (e.g., screws, bolts, rivets, etc.). However, each endcap member 49 may be welded, or secured in any other manner (e.g., a combination of welding and fasteners, etc.), to a respective arm 46. Each endcap member 49 also includes a guide pin 52 that extends outwardly therefrom. The guide pin 52 of each arm 46 is operably engaged with a recess 88 in a respective hitch assembly plate 84, as described below, to limit movement of the hitch assembly 80 relative to the frame 20.

Each guide pin 52 may be fixedly secured to a respective endcap member 52 in various ways. For example, each guide pin 52 may threadingly engage a respective endcap member 49. Alternatively, each guide pin 52 may be fixedly secured to an endcap member 49 via welding or fasteners (e.g., bolts, screws, threaded rods, rivets, etc.) or a combination of welding and fasteners.

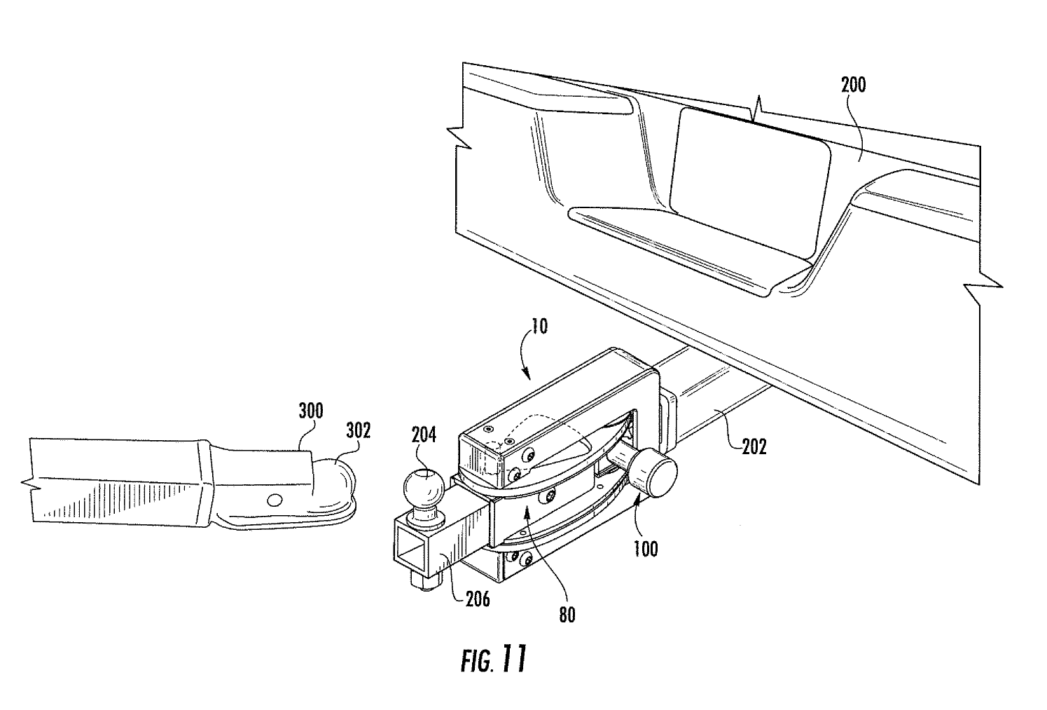

A spool assembly 60, illustrated in FIGS. 5 and 7, is movably associated with the arms 46 of the frame 20 and allows the hitch assembly 80 (FIG. 5) to be moved to extended and retracted positions, as well as to pivot relative to the frame 20. The illustrated spool assembly 60 includes opposite end portions 62a, 62b and an intermediate portion 64 between the opposite end portions 62a, 62b. Each end portion 62a, 62b includes a passageway 66 formed therethrough that is configured to receive a respective guide 48 therethrough. The spool assembly 60 is slidable along the arms 46 via guides 48 so that the hitch assembly 80 can be extended and retracted (FIG. 9).

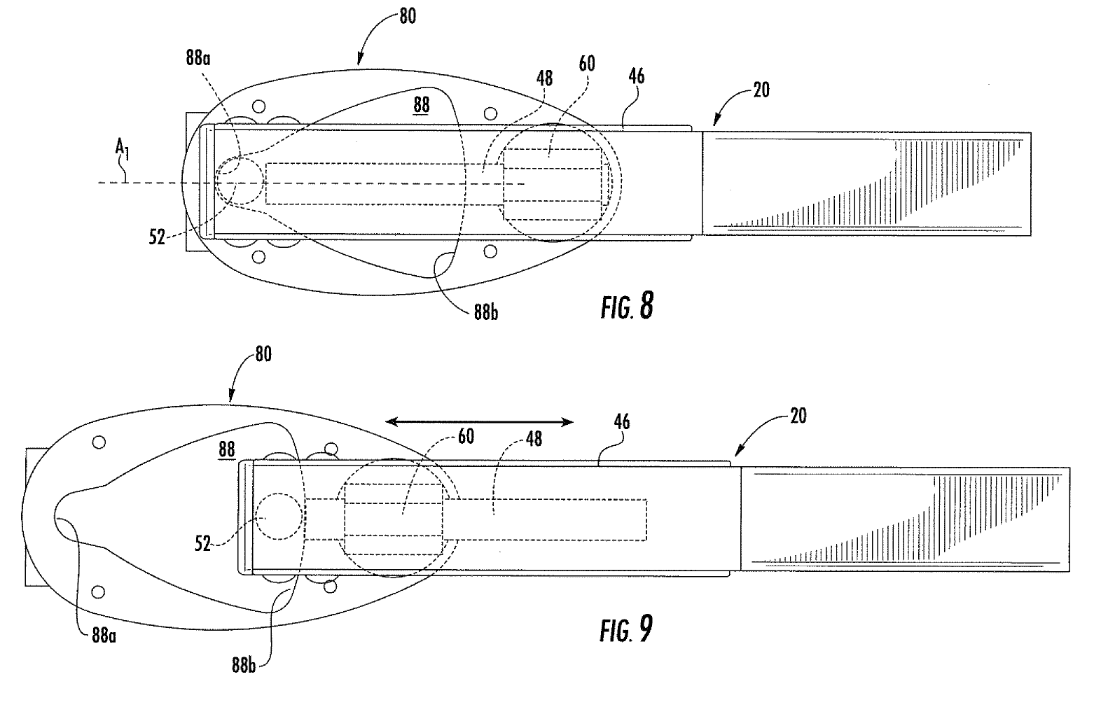

The illustrated spool assembly 60 includes two portions 68 that are substantially identical, as illustrated in FIG. 5. These two portions 68 are secured together via fasteners 69 (e.g., bolts, screws, threaded rods, rivets, etc.) during assembly of the hitch apparatus 10. However, the two portions 68 may be secured together via welding or via a combination of welding and fasteners. Each portion 68 includes a substantially cylindrical peripheral wall 70 and a shoulder 72 extending radially outward from and adjacent to the peripheral wall 70. The peripheral wall 70 of each spool assembly portion 68 is configured to be inserted within and matingly engage a respective hitch assembly plate aperture 86 (FIG. 6) during assembly of the hitch apparatus 10. The two spool assembly portions 68 are then secured together at respective end portions 62c, 62d to form the spool assembly intermediate portion 64. Once the spool assembly portions 68 are secured together, the shoulders 72 at each end of the spool assembly 60 maintain the spool assembly 60 in alignment with the hitch assembly plates 84 (FIG. 5). The outer surface 70a of each peripheral wall 70 serves as a bearing surface to facilitate rotation of the hitch assembly 80 relative to the spool assembly 60.

The end portions 62c, 62d of the two spool assembly portions 68 each have an aperture 65 formed therethrough, as illustrated in FIG. 5. When the end portions 62c, 62d of the two spool assembly portions 68 are secured together, the apertures 65 are aligned to produce an aperture 67 through the spool assembly intermediate portion 64. As described below, a locking member 102 engages aperture 67 to releasably retain the hitch assembly 80 in a retracted position.

As illustrated in FIGS. 5 and 6, the hitch assembly 80 includes a hitch box 82 sandwiched between and secured to a pair of spaced apart plate members 84. The illustrated hitch box 82 is a tube or socket configured to receive and retain various types of towing devices/coupling apparatus (e.g. ball mounts, lunette ring mounts, etc.) therein. Hitch box 82 may have various shapes and configurations, without limitation. The hitch box 82 may be a unitary tubular member or may be a tubular member formed via multiple plates or members. A coupling apparatus is retained within the hitch box 82 via a pin inserted through apertures 83 in the hitch box 82 and corresponding apertures in the coupling apparatus, as would be understood by those skilled in the art.

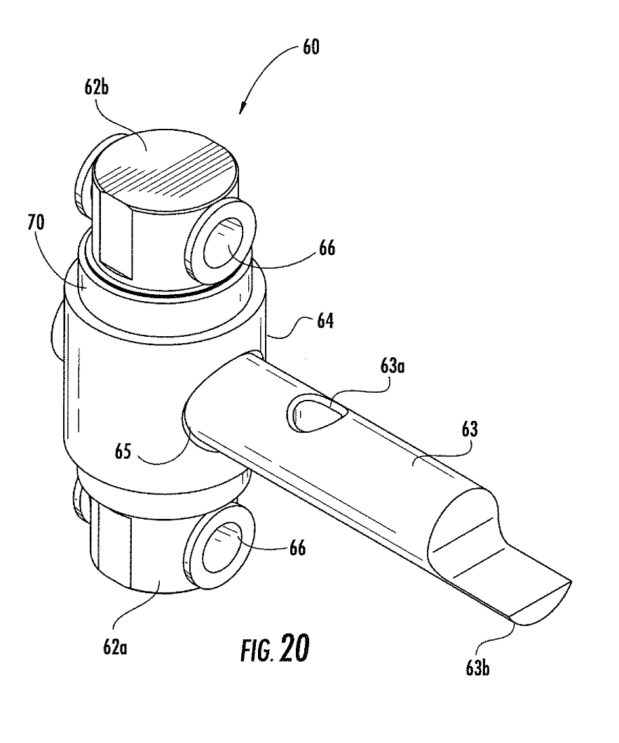

Each plate member 84 has a generally oval shape (although other shapes are possible) with an aperture 86 formed therethrough at one end of the plate member 84, as illustrated. Each plate member 84 also includes a recess 88 formed in an outer surface 84a adjacent to the aperture 86. In some embodiments of the present invention, recess 88 may also be an opening formed completely through each plate member 84 (e.g., opening 88′ in FIG. 19). A guide pin 52 of each arm 46 is positioned within a respective recess 88 and is maintained therein by the peripheral wall 90. The cooperation of each guide pin 52 and recess 88 limits the movement of the hitch assembly 80 relative to the frame 20 (i.e., retraction, extension, and pivotal movement). In addition, as will be described below, the peripheral wall 90 of each recess 88 serves as a guide for moving the hitch assembly 80 to the retracted position after a hitch connection between a towing vehicle and a towed vehicle has been made.

The illustrated recess 88 in each plate member 84 has a substantially triangular shape with slightly arcuate sides (i.e., portions of the peripheral wall 90 are arcuate). As illustrated, the width of the recess 88 decreases in the direction away from the aperture 86. It is this substantially triangular shape that governs the extent to which the hitch assembly 80 can pivot relative to the frame 20 during extension and retraction thereof. Recess 88 can have various shapes and configurations and is not limited to the illustrated configuration.

As illustrated in FIGS. 1, 4 and 5, the hitch apparatus 10 includes a locking mechanism 100 operably attached to the frame 20 via bracket 101. The locking mechanism 100 releasably engages the spool assembly 60 to maintain the hitch assembly 80 in a retracted position. When the hitch assembly 80 is fully retracted, the aperture 67 in the spool assembly intermediate portion 64 is aligned with the apertures 37 in the pair of adjacent, spaced-apart walls 36 that extend away from the first side 32a of the base 32. The locking mechanism 100 includes a locking member 102, such as a rod or bolt, that is inserted through apertures 37 and 67 to retain the spool assembly 60 and hitch assembly 80 in the fully retracted position.

In some embodiments, the locking mechanism 100 includes a biasing element (not shown), such as a spring, that compressively biases or urges the locking member 102 toward a locking position (i.e., the locking member 102 is urged in the direction of the apertures 37, 67). The illustrated locking member 102 includes a free end portion 104 that is configured to be gripped by a user such that the user can pull the locking member 102 outwardly from the frame 20 and disengage the locking member 102 from the spool assembly 60. The locking member 102 is configured to slide on top of or against a member and then move into engagement with the spool assembly when the hitch assembly is fully retracted.

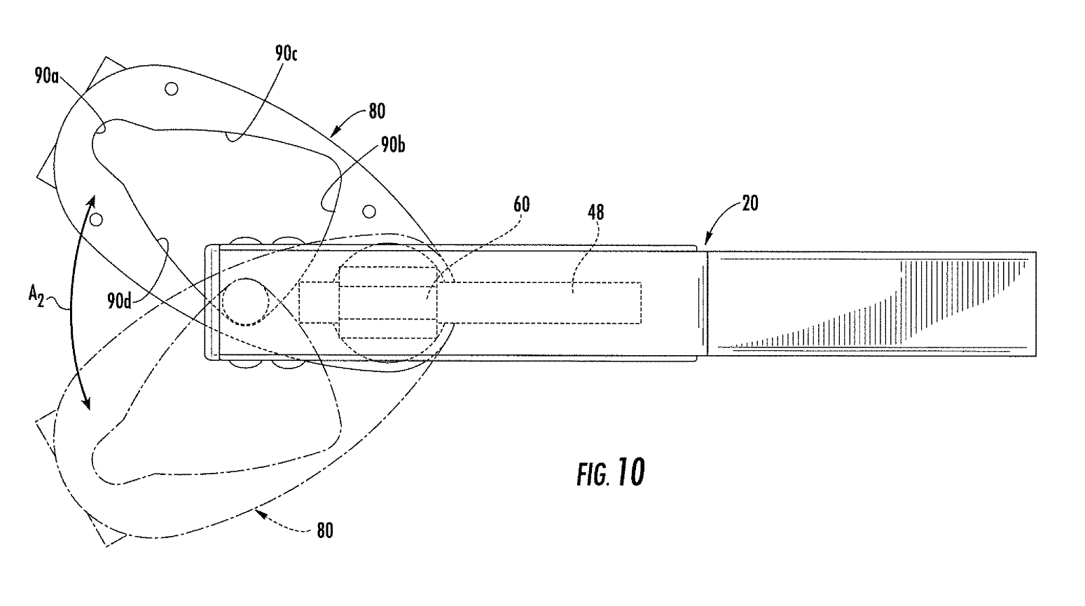

Operation of the hitch apparatus 10 is illustrated in FIGS. 8-13. FIGS. 8-10 illustrate the telescopic movement (i.e., extending and retracting) of the hitch assembly 80 relative to the frame 20. In FIG. 8 the hitch assembly 80 is in a fully retracted position relative to the frame 20. The guide pin 52 of each arm 46 is located in recess portion 88a of a respective recess 88. The hitch assembly 80 is prevented from further movement in the retracted direction because the peripheral wall 90a at recess location 88a contacts the stationary guide pin 52 of a respective arm 46. In addition, pivotal movement of the hitch assembly 80 is restricted because of the configuration of recess portion 88a. Recess portion 88a is not much larger than the diameter of the guide pin 52 and substantially surrounds approximately half of the guide pin 52 thereby limiting pivotal movement of the hitch assembly 80 when fully retracted (FIG. 8).

In FIGS. 9 and 10, the hitch assembly 80 has been moved to a fully extended position. In the fully extended position, the guide pin 52 of each arm 46 contacts the peripheral wall 90b at the other end of the recess 88 indicated as 88b. The range of pivotal movement (indicated by A₂) of the hitch assembly 80 is greatest when the hitch assembly 80 is fully extended and the guide pin 52 of each arm 46 engages peripheral wall portion 90b. Peripheral wall portion 90b also serves as a stop to limit how far the hitch assembly 80 can be extended. The range of pivotal movement A₂ decreases as the hitch assembly is retracted.

Peripheral wall portions 90c, 90d converge toward the recess portion 88a and peripheral wall portion 90a. In other words, the width between peripheral wall portions 90c and 90d is greatest adjacent the peripheral wall portion 90b and smallest adjacent the peripheral wall portion 90a. This converging configuration of peripheral wall portions 90c and 90d also causes the extent to which the hitch assembly 80 can pivot (i.e., A₂) to decrease as the hitch assembly 80 is retracted and, conversely, also causes the extent to which the hitch assembly 80 can pivot (i.e., A₂) to increase as the hitch assembly 80 is extended. In addition, peripheral wall portions 90c, 90d, via contact with the guide pins 52, guide the hitch assembly 80 as it is being retracted to the fully retracted position (FIG. 8).

Referring to FIGS. 11-13, operations for attaching a vehicle to be towed to the hitch apparatus 10, which is attached to a towing vehicle 200, are illustrated. The hitch apparatus 10 is attached to the towing vehicle 200 via the frame member 34 inserted within socket member 202. In FIG. 11, the towing vehicle is backed up to within a close proximity of the hitch 300 of the towed vehicle. The locking mechanism 100 is manipulated by a user so as to remove the locking member 102 from spool assembly aperture 67 and such that the hitching assembly 80 can be extended. Although illustrated as being completely removed from the frame 20, the locking member 102 may be attached to the frame and the user may pull the locking member 102 against the biasing force of a spring such that the spool assembly 60 can be released from the locking member 102. The hitch assembly 80 is then extended and pivoted into position such that the ball 204 of ball mount 206 can engage the hitch socket 302.

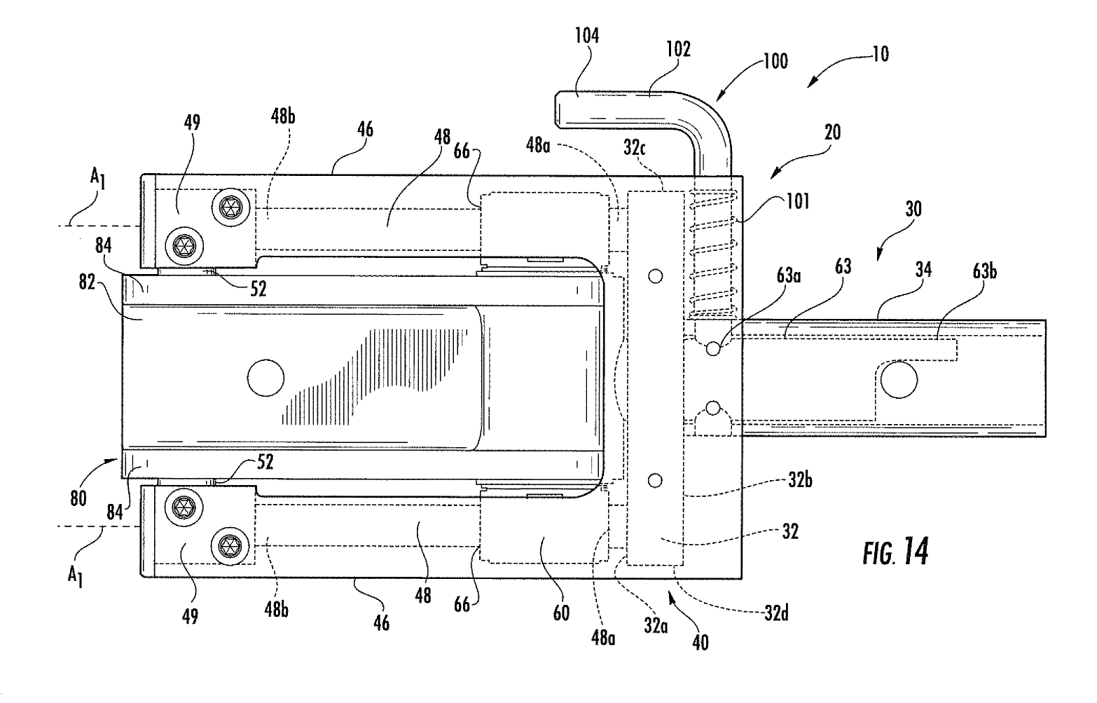

Once the ball 204 is properly secured within the hitch socket 302, the towing vehicle and towed vehicle are moved toward each other such that the hitch assembly 80 moves to the fully retracted position. The locking member 100 is then inserted through apertures 37 and 67 to securely retain the hitch assembly 80 in the fully retracted position, as illustrated in FIG. 13. Movement of the towing vehicle 200 toward the towed vehicle can be accomplished, for example, by backing the towing vehicle up or, for example, by driving the towing vehicle 200 forward and then stopping such that the towed vehicle moves forward.

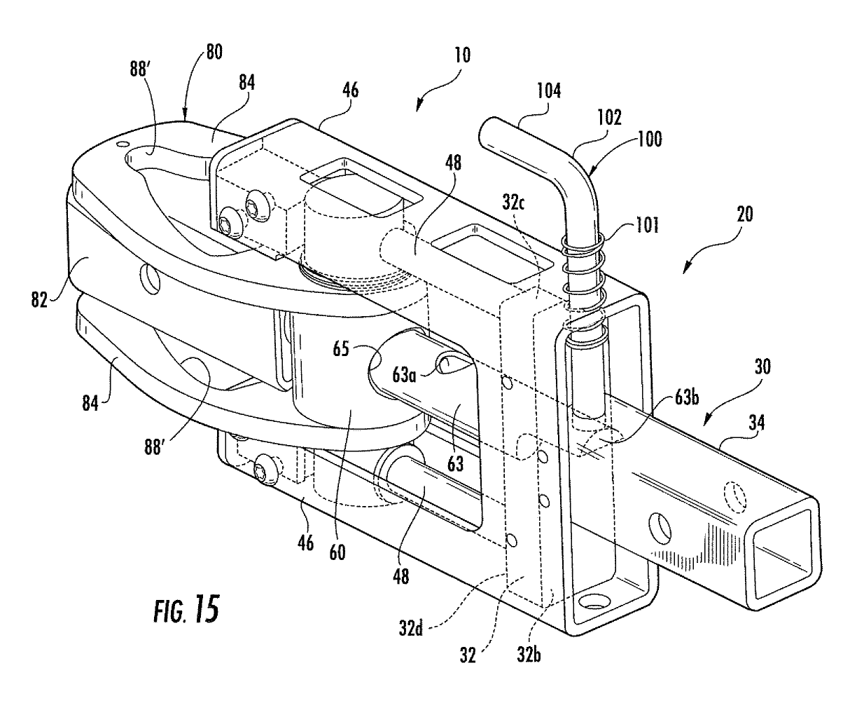

Referring to FIGS. 14-20, a hitch apparatus 10, according to other embodiments of the present invention, is illustrated therein. Operation of the hitch apparatus 10 of FIGS. 14-20 is substantially the same as described above with respect to the hitch apparatus of FIGS. 1-13.

The illustrated hitch apparatus 10 of FIGS. 14-20 includes a frame 20, a spool assembly 60, and a hitch assembly 80. The hitch assembly 80 is movably secured to the frame 20 via the spool assembly 60 so as to be movable between retracted and extended positions. In addition, the hitch assembly 80 is pivotable relative to the frame 20, via the spool assembly 60, when in extended positions. As described above with respect to the hitch apparatus 10 illustrated in FIGS. 1-13, an extent to which the hitch assembly 80 can pivot relative to the frame 20 progressively increases as the hitch assembly 80 is progressively extended. Conversely, an extent to which the hitch assembly 80 can pivot relative to the frame 20 progressively decreases as the hitch assembly 80 is progressively retracted.

The illustrated frame 20 has a tuning fork configuration and comprises a base assembly 30 and an arm assembly 40. The base assembly 30 includes an elongated base 32 having opposite first and second sides 32a, 32b, and opposite end portions 32c, 32d. An elongated member 34 extends away from the second side 32b of the base 32 and is adapted to couple with a socket member 202 (e.g., a receiver hitch, etc.) mounted to a vehicle 200 (FIGS. 11-13). In some embodiments, the elongated member 34 may be configured/modified to be bolted or otherwise attached to a towed vehicle or towing vehicle without the use of a receiver hitch.

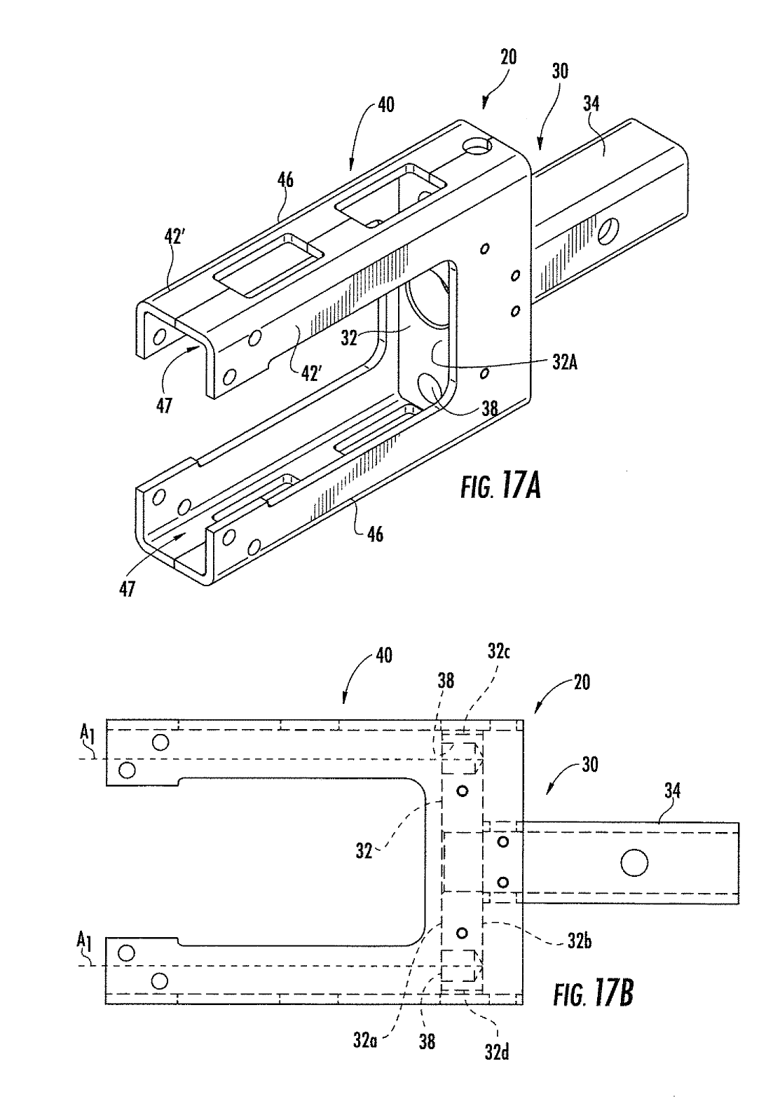

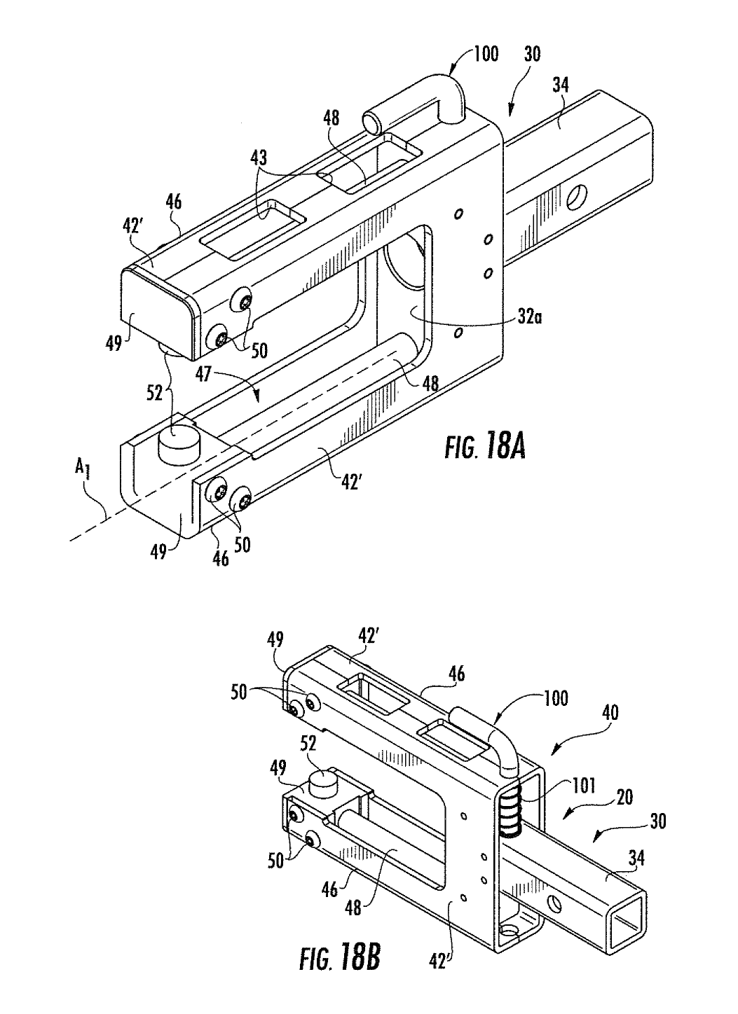

As illustrated in FIG. 17B, each end portion 32c, 32d of the base 32 includes a bore 38 formed therein that terminates at an opening in the first side 32a of the base. Each bore 38 is configured to secure an end portion of a respective elongated rod 48 that serves as a guide for slidably supporting the spool assembly 60. The base assembly 30 is coupled to an arm assembly 40 such that the member 34 extends away from the arm assembly 40. The illustrated arm assembly 40 has a U-shaped configuration and includes a pair of U-shaped members 42′ joined together (FIG. 16). The base assembly 30 and arm assembly 40 are fixedly secured to each other via welding or fasteners (e.g., bolts, screws, threaded rods, rivets, etc.) or a combination of welding and fasteners.

The U-shaped members 42′ define a pair of elongated arms 46 in adjacent, spaced-apart relationship. The arms 46 lie substantially within the same plane, as illustrated. The orientation of arms 46 and member 34 give the frame 20 its tuning fork shape. Each arm 46 has a U-shaped chamber 47 (FIG. 17A) that extends along and about a longitudinal axis A₁ (FIG. 17B).

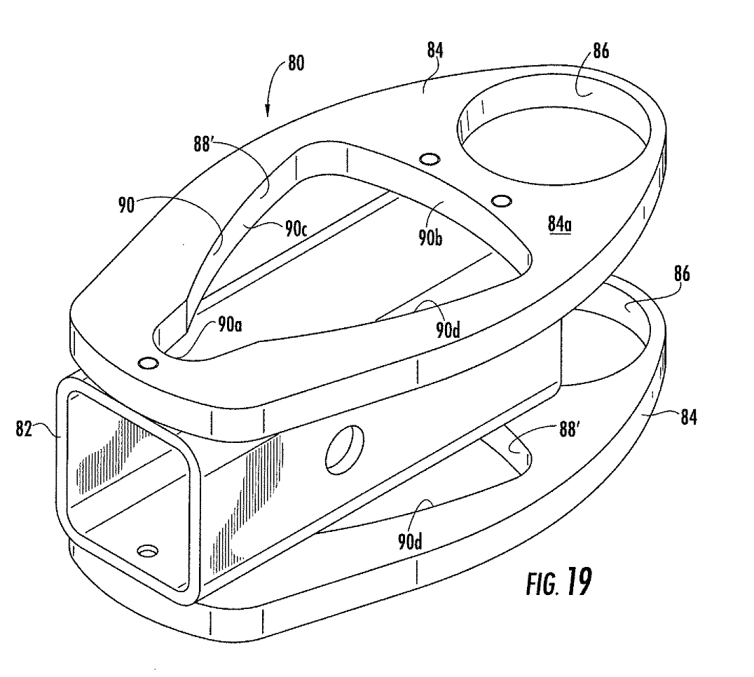

As illustrated in FIGS. 18A-18B, an elongated guide 48 is disposed within the chamber 47 of each arm 46 and extends along the longitudinal axis A₁ thereof. In the illustrated embodiment, each elongated guide 48 is an elongated rod having a substantially circular cross section. However, guide 48 may have various configurations and shapes as long as the spool assembly 60 can be slidably secured thereto so that the hitch assembly 80 can be extended and retracted.

In the illustrated embodiment, a first end 48a of each elongated guide 48 is secured within a respective bore 38 in the base 32 (FIG. 14). An opposite second end 48b of each elongated guide 48 is secured within a respective endcap member 49 that is attached to the free end of each arm 46 (FIG. 14). Each endcap member 49 is secured to a respective arm free end via a plurality of fasteners 50 (e.g., screws, bolts, rivets, etc.). However, each endcap member 49 may be welded, or secured in any other manner, to a respective arm 46. Each endcap member 49 also includes a guide pin 52 that extends outwardly therefrom. The guide pin 52 of each arm 46 is operably engaged with an opening 88′ in a respective hitch assembly plate 84 to limit movement of the hitch assembly 80 relative to the frame 20.

Each guide pin 52 may be fixedly secured to a respective endcap member 52 in various ways. For example, each guide pin 52 may threadingly engage a respective endcap member 49. Alternatively, each guide pin 52 may be fixedly secured to an endcap member 49 via welding or fasteners (e.g., bolts, screws, threaded rods, rivets, etc.) or a combination of welding and fasteners.

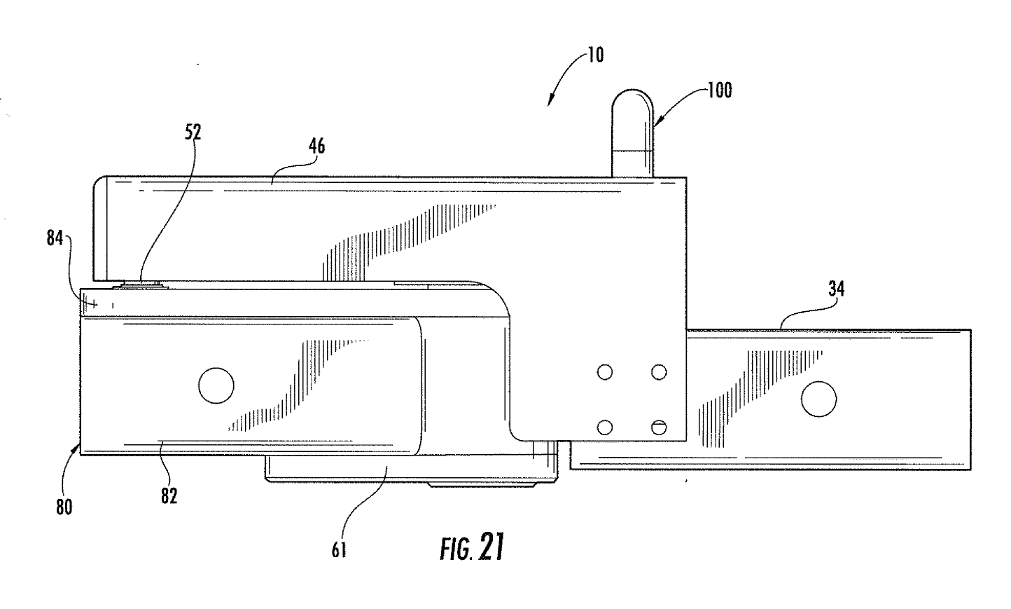

A spool assembly 60 (FIG. 20) is movably associated with the arms 46 of the frame 20 and allows the hitch assembly 80 to be moved to extended and retracted positions, as well as to pivot relative to the frame 20 as described above with respect to the hitch apparatus 10 of FIGS. 1-13. Referring to FIG. 20, the spool assembly 60 includes opposite end portions 62a, 62b and an intermediate portion 64 between the opposite end portions 62a, 62b. Each end portion 62a, 62b includes a passageway 66 formed therethrough that is configured to receive a respective guide 48 therethrough. The spool assembly 60 is slidable along the arms 46 via guides 48 so that the hitch assembly 80 can be extended and retracted.

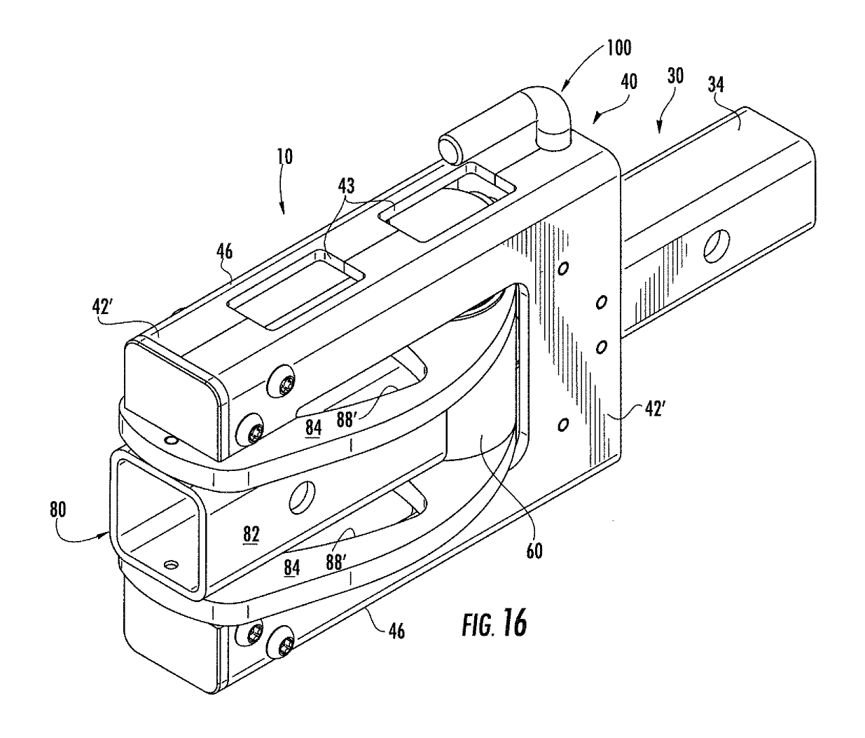

Each end portion 62a, 62b of the illustrated spool assembly 60 includes a substantially cylindrical peripheral wall 70 that is configured to be inserted within, and matingly engage, a respective hitch assembly plate aperture 86 during assembly of the hitch apparatus 10. The outer surface 70a of each peripheral wall 70 serves as a bearing surface to facilitate rotation of the hitch assembly 80 relative to the spool assembly 60. The spool assembly 60 also includes a locking member retaining arm 63 that is secured to the spool assembly intermediate portion 64 (FIGS. 14-15). In the illustrated embodiment, the retaining arm 63 is secured to the spool assembly intermediate portion 64 via a bore 65 in the spool assembly intermediate portion 64. The retaining arm 63 may be threadingly engaged with the bore 65, or may be secured in some other manner such as via the use of fasteners and/or welding. The retaining arm 63 may have various configurations without limitation. Embodiments of the present invention are not limited to the illustrated retaining arm 63 and how it is connected to the spool assembly 60.

As illustrated in FIG. 19, the hitch assembly 80 includes a hitch box 82 sandwiched between and secured to a pair of spaced apart plate members 84. The illustrated hitch box 82 is a tube or socket configured to receive and retain various types of towing devices/coupling apparatus (e.g. ball mounts, lunette ring mounts, etc.) therein. Hitch box 82 may have various shapes and configurations, without limitation. A coupling apparatus is retained within the hitch box via a pin inserted through apertures 83 in the hitch box 82 and corresponding apertures in the coupling apparatus, as would be understood by those skilled in the art.

Each plate member 84 has a generally oval shape (although other shapes are possible) with an aperture 86 formed therethrough at one end of the plate member 84, as illustrated. Each plate member 84 also includes a larger opening 88′ adjacent to the aperture 86. Each opening 88′ serves the same purpose as recess 88 in the plate members 84 of the hitch apparatus 10 of FIGS. 1-13. A guide pin 52 of each arm 46 is positioned within a respective opening 88′ and is maintained therein by the peripheral wall 90. The cooperation of each guide pin 52 and opening 88′ limits the movement of the hitch assembly 80 relative to the frame 20 (i.e., retraction, extension, and pivotal movement). In addition, the peripheral wall 90 of each opening 88′ serves as a guide for moving the hitch assembly 80 to the retracted position after a hitch connection between a towing vehicle and a towed vehicle has been made.

The illustrated opening 88′ in each plate member 84 has a substantially triangular shape with slightly arcuate sides (i.e., portions of the peripheral wall 90 are arcuate). As illustrated, the width of the opening 88′ decreases in the direction away from the aperture 86. It is this substantially triangular shape that governs the extent to which the hitch assembly 80 can pivot relative to the frame 20 during extension and retraction thereof. Opening 88′ can have various shapes and configurations and is not limited to the illustrated configuration.

As illustrated in FIGS. 14-15, the hitch apparatus 10 includes a locking mechanism 100 operably attached to the frame 20. The locking mechanism 100 releasably engages the spool assembly 60 via retaining arm 63 to maintain the hitch assembly 80 in a retracted position. When the hitch assembly 80 is fully retracted, the locking member 102 extends through passageway 63a in the retaining arm (FIG. 14) to retain the hitch assembly 80 in the fully retracted position. The locking mechanism 100 includes a biasing element 101, such as a spring, that compressively biases or urges the locking member 102 toward a locking position (i.e., the locking member 102 is urged in the direction of the retaining arm 63. The illustrated locking member 102 includes a handle 104 that is configured to be gripped by a user such that the user can pull the locking member 102 upwardly and disengage the locking member 102 from the retaining arm passageway 63a.

When the locking member 102 is disengaged from the retaining arm passageway 63a and the hitch assembly 80 is moved to an extended position, the biasing member 101 urges the locking member 102 into contact with the surface of the retaining arm 63. FIG. 15 illustrates the hitch assembly 80 in a fully extended position and the locking member in contact with the retaining arm 63 near the free end 63b of the retaining arm 63. When the hitch assembly 80 is moved back to the fully retracted position, the biasing member urges the locking member 102 into the retaining arm passageway 63a.

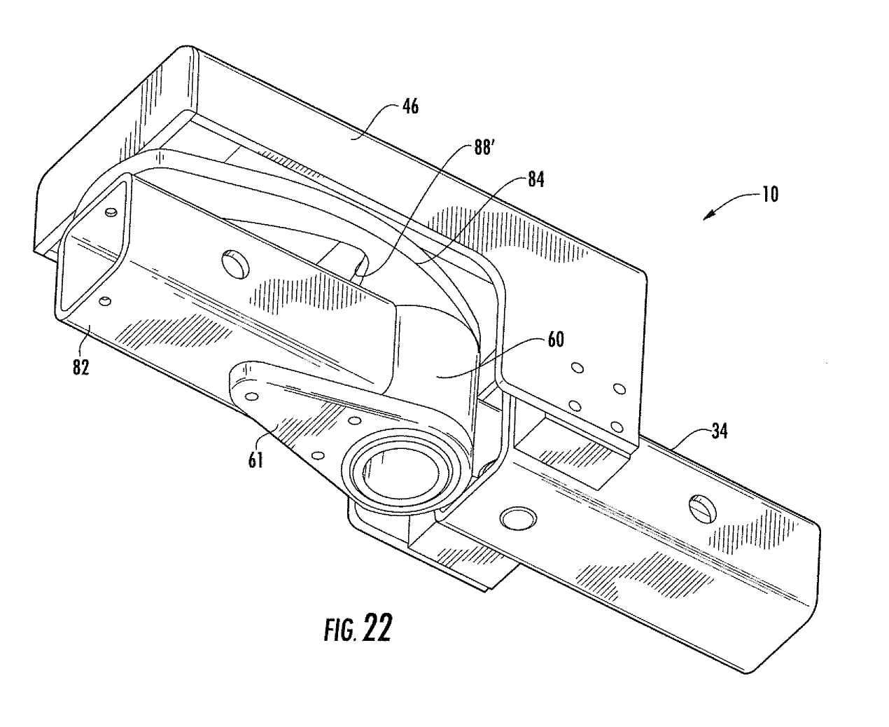

Referring to FIGS. 21-22, a hitch apparatus 10, according to other embodiments of the present invention, is illustrated therein. The illustrated apparatus 10 has an elongated member 34 that is adapted to couple with a socket member 202 (e.g., a receiver hitch, etc.) mounted to a vehicle 200 (FIGS. 11-13). In some embodiments, the elongated member 34 may be configured/modified to be bolted or otherwise attached to a towed vehicle or towing vehicle without the use of a receiver hitch.

Operation of the hitch apparatus 10 of FIGS. 21-22 is substantially the same as described above with respect to the hitch apparatus 10 of FIGS. 1-13 and the hitch apparatus 10 of FIGS. 14-20. The illustrated hitch apparatus 10 of FIGS. 21-22 is substantially identical to the hitch apparatus 10 of FIGS. 14-20 with the exception that only one arm 46 is utilized. The single arm 46 has a guide pin 52 that cooperates with an opening 88′ in plate member 84 of the hitch assembly 80, as described above with respect to the hitch apparatus 10 of FIGS. 14-20. In other embodiments of the present invention, the plate member 84 may include a recess 88 in lieu of the opening 88′ that cooperates with guide pin 52. The spool assembly 60 is slidably supported by the single arm 46 in the same way as described above (i.e., via an elongated guide 48). In lieu of a second plate member, the illustrated hitch assembly 80 includes a support member 61 attached to the hitch box 82 and rotatably secured to the spool assembly 60.

However, in some embodiments, a pair of guides, such as elongated rods (not shown), may be supported by the single arm 46 in adjacent, spaced-apart relationship. The pair of side-by-side guides slidably support the spool assembly 60 and allow the spool assembly 60 to move between extended and retracted positions. In this embodiment, a pair of side-by-side passageways (such as passageway 66 illustrated in FIG. 7) are formed through one end of the spool assembly 60 and each is configured to receive a respective one of the pair of guides therethrough.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the teachings and advantages of this invention. Accordingly, all such modifications are intended to be included within the scope of this invention as defined in the claims. The invention is defined by the following claims, with equivalents of the claims to be included therein.

That which is claimed is:

1. A hitch apparatus, comprising:
a frame comprising an arm; and
a hitch assembly movable along the arm between retracted and extended positions and pivotably relative to the frame when in an extended position.

2. The hitch apparatus of claim 1, further comprising a spool assembly movably secured to the arm such that the spool assembly is slidable along the arm, and wherein the hitch assembly is pivotably secured to the spool assembly.

3. The hitch apparatus of claim 2, further comprising a locking mechanism operably secured to the frame that releasably engages the spool assembly to maintain the hitch assembly in a retracted position.

4. The hitch apparatus of claim 2, wherein the arm includes an elongated guide, and wherein the spool assembly is movably secured to the elongated guide.

5. The hitch apparatus of claim 2, wherein the arm includes a guide pin that extends outwardly therefrom, wherein the hitch assembly comprises a plate member having an aperture formed therethrough and a recess formed in an outer surface thereof adjacent to the aperture, wherein the spool assembly is pivotably secured within the aperture, and wherein the guide pin is operably engaged with the recess to limit movement of the hitch assembly relative to the frame.

6. The hitch apparatus of claim 5, wherein the recess is an opening.

7. The hitch apparatus of claim 5, wherein the recess has a configuration that limits an extent to which the hitch assembly can pivot relative to the frame.

8. The hitch apparatus of claim 5, wherein the hitch assembly comprises a hitch box secured to the plate member, wherein the hitch box is configured to receive a coupling apparatus therein.

9. A hitch apparatus, comprising:
a frame, comprising:
a base;
a pair of arms extending away from one side of the base in side by side, spaced-apart relationship; and
a member extending away from an opposite side of the base, wherein the member is adapted to be attached to a vehicle; and
a hitch assembly movably secured to the arms, wherein the hitch assembly is movable along the arms between retracted and extended positions relative to the base, and wherein the hitch assembly is pivotable relative to the frame when in an extended position.

10. The hitch apparatus of claim 9, wherein the pair of arms lie substantially within a first plane, and wherein the hitch assembly is pivotable within a second plane that is transverse to the first plane.

11. The hitch apparatus of claim 9, wherein the first and second planes are substantially perpendicular.

12. The hitch apparatus of claim 9, further comprising a spool assembly having opposite end portions, wherein each end portion is movably secured to a respective arm such that the spool assembly is slidable along the arms, and wherein the hitch assembly is pivotably secured to the spool assembly.

13. The hitch apparatus of claim 12, further comprising a locking mechanism operably secured to the frame that releasably engages the spool assembly to maintain the hitch assembly in a retracted position.

14. The hitch apparatus of claim 13, wherein the spool assembly comprises an intermediate portion between the opposite end portions, and wherein the locking mechanism releasably engages the spool assembly intermediate portion.

15. The hitch apparatus of claim 13, wherein the locking mechanism comprises a biasing member and a locking member, and wherein the locking member is compressively biased toward the spool assembly.

16. The hitch apparatus of claim 15, wherein the locking member comprises a portion configured to be gripped by a user such that the user can disengage the locking member from the spool assembly.

17. The hitch apparatus of claim 12, wherein each arm includes an elongated guide, and wherein each spool assembly end portion is movably secured to a respective guide.

18. The hitch apparatus of claim 17, wherein each guide comprises an elongated rod.

19. The hitch apparatus of claim 18, wherein each arm comprises a base plate member formed with outwardly-extending wall portions defining a U-shaped chamber about a longitudinal axis thereof, and wherein a respective elongated rod is disposed within the chamber along the longitudinal axis.

20. The hitch apparatus of claim 19, wherein one end of an elongated rod is secured to the base and an opposite end is secured to the arm adjacent a free end of the arm.

21. The hitch apparatus of claim 12, wherein each arm includes a guide pin that extends outwardly therefrom, wherein the hitch assembly comprises a pair of spaced apart plate members, wherein each plate member has an aperture formed therethrough and a recess formed in an outer surface thereof adjacent to the aperture, wherein the spool assembly is pivotably secured within the apertures of the plate members, and wherein the guide pin of each arm is operably engaged with a respective recess to limit movement of the hitch assembly relative to the frame.

22. The hitch apparatus of claim 21, wherein at least one recess is an opening in a respective plate member.

23. The hitch apparatus of claim 20, wherein at least one recess has a configuration that limits an extent to which the hitch assembly can pivot relative to the frame.

24. The hitch apparatus of claim 20, wherein at least one recess has a configuration such that an extent to which the hitch assembly can pivot relative to the frame progressively decreases as the hitch assembly is progressively retracted.

25. The hitch apparatus of claim 20, wherein each recess has a peripheral wall that contacts a respective guide pin to limit movement of the hitch assembly relative to the frame.

26. The hitch apparatus of claim 25, wherein the peripheral wall comprises arcuate portions.

27. The hitch apparatus of claim 20, wherein the hitch assembly comprises a hitch box positioned between and secured to the plate members, wherein the hitch box is configured to receive a coupling apparatus therein.

28. The hitch apparatus of claim 20, wherein each end portion of the spool assembly comprises a portion that matingly engages an aperture in a respective plate and that allows the hitch assembly to pivot about the spool assembly.

29. A hitch apparatus, comprising:
a frame having a tuning fork configuration with a pair of arms extending along a direction in side by side, spaced-apart relationship; and
a hitch assembly movably secured to the arms, wherein the hitch assembly is movable along the arms between retracted and extended positions, wherein the hitch assembly is pivotable relative to the frame when in an extended position, and wherein an extent to which the hitch assembly can pivot relative to the frame progressively increases as the hitch assembly is progressively extended.

30. The hitch apparatus of claim 29, wherein the pair of arms lie substantially within a first plane, and wherein the hitch assembly is pivotable within a second plane that is transverse to the first plane.

31. The hitch apparatus of claim 29, further comprising a spool assembly having opposite end portions, wherein each end portion is movably secured to a respective arm such that the spool assembly is slidable along the arms, and wherein the hitch assembly is pivotably secured to the spool assembly.

32. The hitch apparatus of claim 31, further comprising a locking mechanism operably secured to the frame that releasably engages the spool assembly to maintain the hitch assembly in a retracted position.

33. The hitch apparatus of claim 31, wherein each arm includes a guide pin that extends outwardly therefrom, wherein the hitch assembly comprises a pair of spaced apart plate members, wherein each plate member has an aperture formed therethrough and a recess formed in an outer surface thereof adjacent to the aperture, wherein the spool assembly is pivotably secured within the apertures of the plate members, and wherein a guide pin of each arm is operably engaged with a respective recess to limit movement of the hitch assembly relative to the frame.

34. The hitch apparatus of claim 33, wherein each recess is an opening in a respective plate member.

35. The hitch apparatus of claim 33, wherein each recess has a configuration that limits an extent to which the hitch assembly can pivot relative to the frame.

36. A hitch apparatus, comprising:
a pair of spaced apart plate members, wherein each plate member has an aperture formed therethrough and a recess formed in an outer surface thereof adjacent to the aperture; and
a hitch box positioned between and secured to the plate members, wherein the hitch box is configured to receive a coupling apparatus therein.

37. The hitch apparatus of claim 36, wherein each recess has a substantially triangular shape with arcuate sides.

38. The hitch apparatus of claim 36, wherein the width of each recess in a plate decreases in a direction away from the respective plate aperture.

39. The hitch apparatus of claim 36, further comprising a spool assembly having opposite end portions, wherein each end portion of the spool assembly comprises a portion that is pivotably secured within an aperture in a respective plate.

40. The hitch apparatus of claim 36, wherein each recess is an opening in a respective plate member.

41. A hitch apparatus, comprising:
a plate member having an aperture formed therethrough and a recess formed in an outer surface thereof adjacent to the aperture; and
a hitch box secured to the plate member, wherein the hitch box is configured to receive a coupling apparatus therein.

42. The hitch apparatus of claim 41, wherein the recess has a substantially triangular shape with arcuate sides.

43. The hitch apparatus of claim 41, wherein the width of the recess decreases in a direction away from the aperture.

44. The hitch apparatus of claim 41, further comprising a spool assembly having an end portion pivotably secured within the aperture.

45. The hitch apparatus of claim 41, wherein the recess is an opening in the plate member.
